(19) United States
(12) Patent Application Publication
(10) Pub. No.: US 2018/0187626 A1
(43) Pub. Date: Jul. 5, 2018

(54) COMBUSTION BOWL OF A PISTON FOR AN ENGINE

(71) Applicant: Caterpillar Inc., Peoria, IL (US)

(72) Inventor: David T. Montgomery, Edelstein, IL (US)

(73) Assignee: Caterpillar Inc., Peoria, IL (US)

(21) Appl. No.: 15/398,485

(22) Filed: Jan. 4, 2017

(51) Int. Cl. F02F 3/26; F02F 1/24; F02F 7/00; F02M 61/14

(52) U.S. Cl. CPC F02F 3/26; F02M 61/14; F02F 7/0021; F02F 1/242

(57) ABSTRACT

A piston for an engine may include a body. The body may extend between a first and second axial region. A piston crown may be disposed at the first axial region symmetrically about a central longitudinal axis of the piston. A first bowl may be recessed into the body and may include a first curved wall transitioning into the piston crown at a bowl lip. The bowl lip may include a bowl lip diameter. The first curved wall may include a first wall diameter greater than the bowl lip diameter. A second bowl may be recessed into the body and disposed axially inwardly from the first bowl. The second bowl may include a second curved wall transitioning into the first bowl at a peak. The peak may include a peak diameter. The second curved wall may include a second wall diameter greater than the peak diameter.

### TECHNICAL FIELD

The present disclosure relates generally to pistons for engines and, more particularly, relates to combustion bowls of such pistons.

### BACKGROUND

Fuel combustion in engines, such as, but not limited to, natural gas engines, diesel engines, gasoline engines, and other engines well-known in the industry, typically produce a complex mixture of exhaust by-products. Such exhaust by-products may include hydrocarbons emissions, oxides of nitrogen (NOₓ), and particulate matter, such as soot and ash, and are generally undesirable. Efforts are continuously being made to further reduce the levels of these exhaust by-products from being emitted into the environment. Developing ways to minimize the levels of these exhaust by-products, however, often involves a balancing between achieving acceptable reduction levels and maintaining combustion efficiency.

Various combustion chamber designs have been attempted to reduce the generation of exhaust by-products without sacrificing combustion efficiency. For example, the structural shape of the combustion bowl, which is generally disposed in the combustion face of a piston and defines a portion of the combustion chamber, may be configured to produce a desired distribution of fuel and air in the combustion chamber.

U.S. Pat. No. 7,942,126 (the '126 patent) discloses a piston top having an integrally formed piston recess. The piston recess includes an annular stepped space. The stepped space of the piston interacts operatively with a combustion space to promote fuel deflection within the combustion space. While the object of the combustion chamber of the '126 patent is to reduce generation of soot and smoke, improvements in reducing exhaust by-products continue to be sought.

### SUMMARY

In accordance with an aspect of the disclosure, a piston for an engine is provided. The piston may comprise a body extending between a first axial region and a second axial region. A piston crown may be disposed at the first axial region symmetrically about a central longitudinal axis of the piston. A first bowl may be recessed into the body and may include a first curved wall. The first curved wall may transition into the piston crown at a bowl lip. The bowl lip may include a bowl lip diameter. The first curved wall may include a first wall diameter. The first wall diameter may be greater than the bowl lip diameter. A second bowl may be recessed into the body and may be disposed axially inwardly from the first bowl. The second bowl may include a second curved wall. The second curved wall may transition into the first bowl at a peak. The peak may include a peak diameter. The second curved wall may include a second wall diameter. The second wall diameter may be greater than the peak diameter.

In accordance with another aspect of the disclosure, an engine is provided. The engine may comprise an engine housing including a cylinder disposed therein. The cylinder may include a cylinder diameter. A cylinder head may be coupled to the engine housing. The cylinder head may include a fuel injector disposed therethrough. The fuel injector may be configured to inject fuel into the cylinder. A piston may be operatively disposed in the cylinder and may include a piston crown. A combustion bowl may be recessed into the piston and may be disposed symmetrically about the central longitudinal axis. The combustion bowl may include a first bowl and a second bowl. The second bowl may be disposed axially inwardly from the first bowl. The first bowl may include a first re-entrant angle in the range of vertical 0 degrees to 15 degrees. The second bowl may include a second re-entrant angle in the range of vertical 0 degrees to 15 degrees.

In accordance with yet another aspect of the disclosure, a piston for an engine is provided. The piston may comprise a body extending between a first axial region and a second axial region. A piston crown may be disposed at the first axial region symmetrically about a central longitudinal axis of the piston. A first bowl may be recessed into the body and may include a first re-entrant angle in the range of vertical 0 degrees to 15 degrees. A second bowl may be recessed into the body and may be disposed axially inwardly from the first bowl. The second bowl may include a second re-entrant angle in the range of vertical 0 degrees to 15 degrees.

These and other aspects and features of the present disclosure will be more readily understood upon reading the following detailed description when taken in conjunction with the accompanying drawings. Aspects of different embodiments herein described can be combined with or substituted by one another.

### BRIEF DESCRIPTION OF THE DRAWINGS

FIG. 1 is a perspective view of an exemplary vehicle, in accordance with an embodiment of the present disclosure;

FIG. 2 is a partial cross-sectional view of an engine housing of an engine illustrating a piston operatively disposed in a cylinder, in accordance with an embodiment of the present disclosure;

FIG. 3 is a cross-sectional view of a combustion bowl of a piston, in accordance with an embodiment of the present disclosure;

FIG. 4 is a top plan view of a piston illustrating a combustion bowl thereof, in accordance with an embodiment of the present disclosure;

FIG. 5 is a partial cross-sectional view of the combustion bowl of FIG. 4 taken along line 4-4, in accordance with an embodiment of the present disclosure;

FIG. 6 is a top plan view illustrating a combustion bowl, in accordance with an alternative embodiment of the present disclosure; and

FIG. 7 is a block diagram illustrating a sample sequence of steps which may be practiced in accordance with the teachings of the present disclosure.

It is to be noted that the appended drawings illustrate only typical embodiments and are therefore not to be considered limiting with respect to the scope of the disclosure or claims. Rather, the concepts of the present disclosure may apply within other equally effective embodiments. Moreover, the drawings are not necessarily to scale, emphasis generally being placed upon illustrating the principles of certain embodiments.

### DETAILED DESCRIPTION

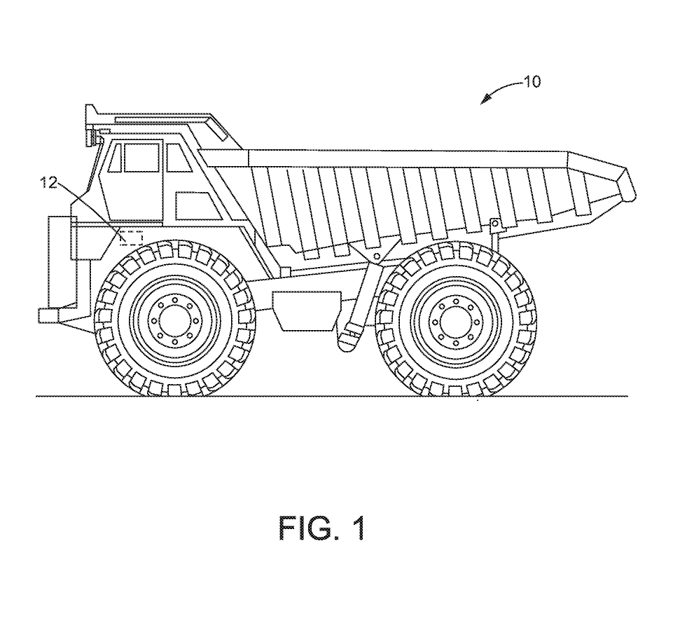

Referring now to FIG. 1, an exemplary vehicle constructed in accordance with the present disclosure is generally referred to by reference numeral 10. Although exemplarily illustrated as an off-highway truck, the vehicle 10 may be any type of vehicle utilized in a wide variety of industries such as, but not limited to, mining, earth-moving, agricultural, petroleum extraction, and construction, to name a few examples. The vehicle 10 includes an engine 12. The engine 12 may be any type of engine such as, but not limited to, natural gas engines, diesel engines, gasoline engines, and other engines well-known in the industry.

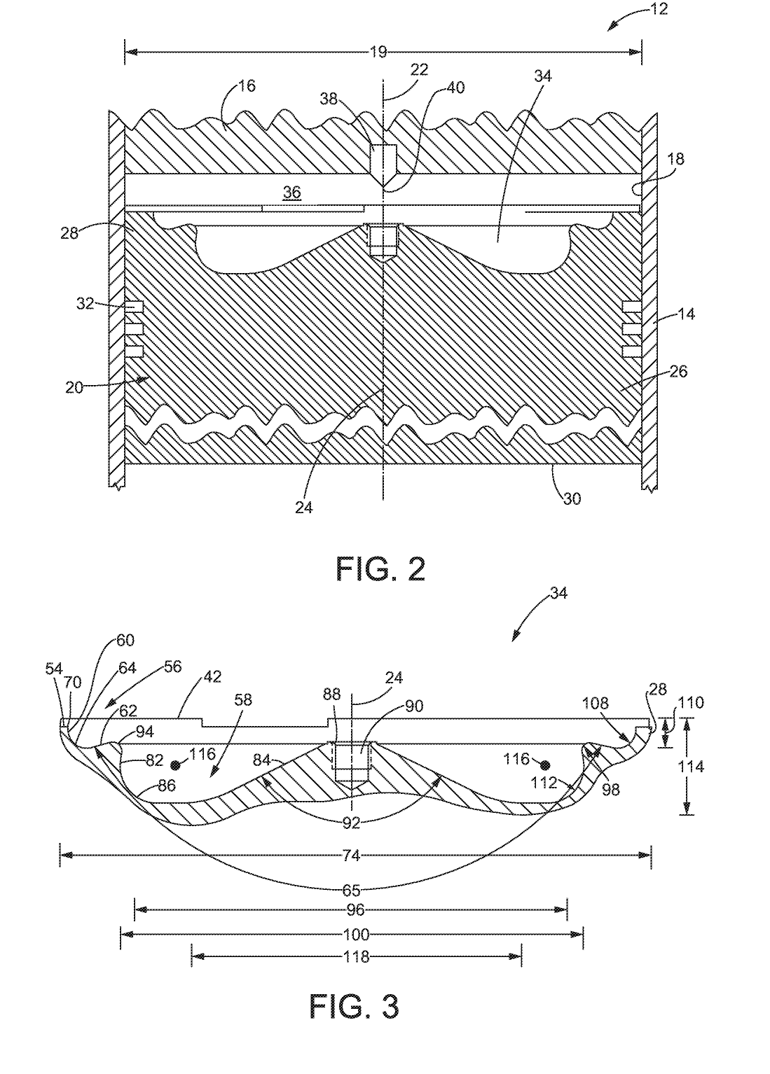

With reference to FIG. 2, the engine 12 includes an engine housing 14 or engine block. A cylinder head 16 is coupled to the engine housing 14. The engine housing 14 includes a cylinder 18 disposed therein. A piston 20 is operatively disposed in the cylinder 18 to reciprocate therein. The cylinder 18 may include a central longitudinal cylinder axis 22 aligned with a central longitudinal piston axis 24 of the piston 20. The cylinder 18 includes a cylinder diameter 19. The cylinder diameter 19 is in the range of approximately 120 mm to 300 mm. In some embodiments, the cylinder diameter 19 is 175 mm. While only one cylinder 18 is described for simplicity, it should be understood that the engine 12 may include any number of cylinders and the cylinders may be disposed in an “in-line” configuration, a “V” configuration, or any other configuration well-known in the industry.

The piston 20 includes a body 26 extending between a first axial region 28 and a second axial region 30 of the piston 20. The body 26 is generally cylindrical in shape. In some embodiments, a plurality of piston ring grooves 32 is disposed into the outer cylindrical surface of the body 26 between the first axial region 28 and the second axial region 30. The plurality of piston ring grooves 32 is configured to receive oil rings, compression rings, or any other rings well-known in the industry. The first axial region 28 of the piston 20 includes a combustion bowl 34 recessed into the body 26. When the piston 20 is operatively arranged within the cylinder 18, the first axial region 28 and the combustion bowl 34 face the cylinder head 16. Further, the engine 12 includes a combustion chamber 36, which may be defined collectively by the cylinder 18, the cylinder head 16, and the combustion bowl 34. The engine 12 also includes a fuel injector 38 disposed through the cylinder head 16 such that a plurality of nozzles 40 of the fuel injector 38 is arranged in the combustion chamber 36. The fuel injector 38 is configured to inject fuel into the combustion chamber 36 toward the combustion bowl 34 via the plurality of nozzles 40. In some embodiments, the fuel injector 38 is disposed symmetrically about the central longitudinal cylinder axis 22. While in some embodiments the plurality of nozzles 40 are also disposed symmetrically about the central longitudinal cylinder axis 22, in other embodiments the plurality of nozzles 40 are not disposed symmetrically such as in the case of double tipped nozzles.

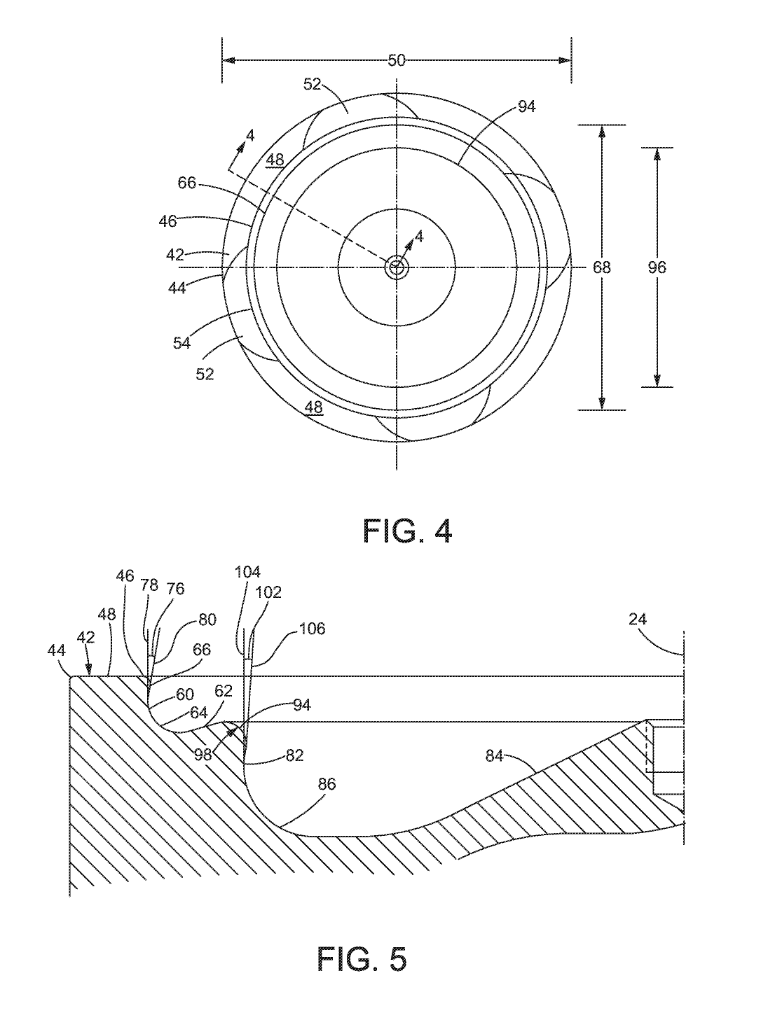

With reference to FIGS. 3 and 4, the combustion bowl 34 of the piston 20 is disposed symmetrically about the central longitudinal piston axis 24. The piston 20 includes a piston crown 42 also disposed symmetrically about the central longitudinal piston axis 24. The piston crown 42 is disposed at the first axial region 28 and includes an outer edge 44, an inner edge 46, and a face 48 disposed between the outer edge 44 and the inner edge 46. The outer edge 44 includes an outer diameter 50. The outer diameter 50 is in the range of approximately 155.38 mm to 189.91 mm and, in some embodiments, is approximately 172.645 mm.

In some embodiments, the piston crown 42 includes a plurality of pockets 52 recessed axially into the face 48. For example, the plurality of pockets 52 may include 4 pockets recessed axially into the face 48 with each pocket of the plurality of pockets 52 equally spaced apart circumferentially from each other, as illustrated in FIG. 4. The plurality of pockets 52 is configured to receive corresponding valves (not shown) operatively disposed in the cylinder head 16 for preventing contacting between the valves and the face 48. Each pocket of the plurality of pockets 52 is recessed axially into the face 48 at an appropriate depth to accommodate receiving the valves such that the valves are prevented from contacting the face 48. In such embodiments, each pocket of the plurality of pockets 52 includes a pocket edge 54 offset axially with respect to, and coaxial with, the inner edge 46 of the piston crown 42.

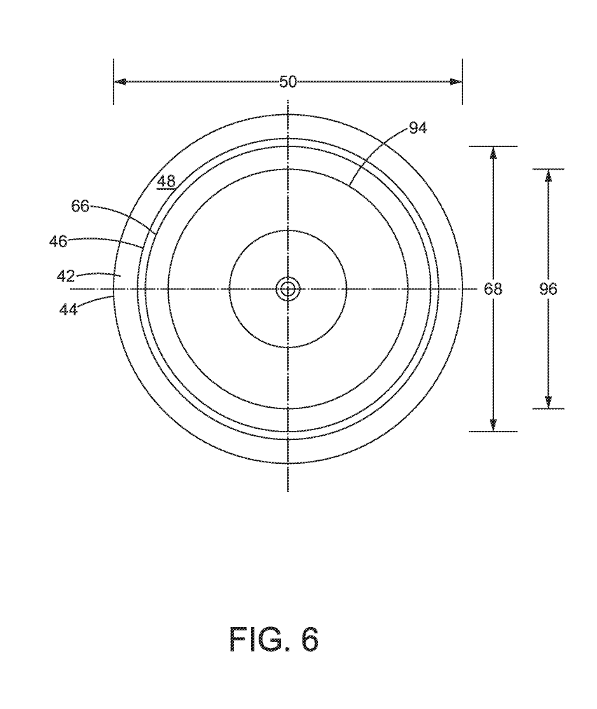

Referring back to FIG. 3, the combustion bowl 34 of the piston 20 includes a first bowl 56 and a second bowl 58. The first bowl 56 is generally annular and concave. The first bowl 56 is aligned radially with the central longitudinal piston axis 24. The first bowl 56 includes a first curved wall 60 and a first floor 62. The first curved wall 60 transitions into the first floor 62 at a first curved surface 64. The first floor 62 and includes a first floor angle 65 in the range of approximately 120 degrees to 180 degrees. Moreover, the first curved wall 60 transitions into the inner edge 46 of the piston crown 42 at a bowl lip 66, as illustrated in FIG. 5. The bowl lip 66 includes a bowl lip diameter 68, as illustrated in FIG. 4. The bowl lip diameter 68 is in the range of approximately 80 percent to 90 percent of the cylinder diameter 19. In some embodiments, the bowl lip diameter 68 is 147.2 mm. In embodiments that include the plurality of pockets 52, the first curved wall 60 also transitions into each pocket edge 54 at a pocket lip 70, as illustrated in FIG. 3. In such embodiments, the pocket lip 70 includes a pocket lip diameter 72 (illustrated in FIG. 4) that is equal to the bowl lip diameter 68.

The first curved wall 60 includes a first wall diameter 74 defined as the largest diameter of the first bowl 56, as illustrated in FIG. 3. As such, the first wall diameter 74 is greater than the bowl lip diameter 68. At the first wall diameter 74, the first curved wall 60 curves radially inwardly as it advances axially toward the bowl lip 66. Further, with particular reference to FIG. 5, the first bowl 56 includes a first re-entrant angle 76 defined as the angle represented by a first tangent line 78 vertically tangent to the first curved wall 60 at the first wall diameter 74 and a second tangent line 80 tangent to the first curved wall 60 and the bowl lip 66. The first re-entrant angle 76 is in the range of approximately vertical 0 degrees and 15 degrees. In some embodiments, the first re-entrant angle 76 is 14 degrees.

With reference to FIGS. 3-5, the second bowl 58 is also aligned radially with the central longitudinal piston axis 24 and is disposed axially inwardly from the first bowl 56. The second bowl 58 is generally annular and concave. The second bowl 58 includes a second curved wall 82 and a second floor 84. The second floor 84 transitions into the second curved wall 82 at a second curved surface 86. Moreover, the second floor 84 is generally frusto-conical and extends between the second curved surface 86 and a central apex 88 that is disposed centrally and symmetrically about the central longitudinal piston axis 24. While the central apex 88 is illustrated to include an aperture 90 disposed therethrough for facilitating in assembly and disassembly, it is to be understand that the central apex 88 may come to a sharp point in some embodiments. As the second floor 84 moves radially outwardly from the central apex 88, it slopes axially in the direction of the second axial region 30 and transitions into the second curved surface 86, which inflects into the second curved wall 82 in the direction of the first axial region 28. The second floor 84 includes a second floor angle 92. The second floor angle 92 is in the range of approximately 120 degrees and 180 degrees. In some embodiments, the second floor angle 92 is 127 degrees.

The second curved wall 82 transitions into the first floor 62 of the first bowl 56 at a peak 94. The peak 94 is generally rounded and annular. The peak 94 includes a peak diameter 96, as illustrated in FIG. 4. The peak diameter 96 is in the range of approximately 62 percent to 72 percent of the cylinder diameter 19. In some embodiments, the peak diameter 96 is approximately 118.3 mm. The peak 94 is disposed radially inwardly of the bowl lip 66. The peak 94 also includes a peak radius 98. The peak radius 98 is in the range of approximately 0.5 mm to 3 mm. In some embodiments, the peak radius 98 is approximately 2 mm.

Moreover, the second curved wall 82 includes a second wall diameter 100 defined as the largest diameter of the second bowl 58, as illustrated in FIG. 3. As such, the second wall diameter 100 is greater than the peak diameter 96. At the second wall diameter 100, the second curved wall 82 curves radially inwardly as it advances axially toward the peak 94. Further, with particular reference to FIG. 5, the second bowl 58 includes a second re-entrant angle 102 defined as the angle represented by a third tangent line 104 vertically tangent to the second curved wall 82 at the second wall diameter 100 and a fourth tangent line 106 tangent to the second curved wall 82 and the peak 94. The second re-entrant angle 102 is in the range of approximately vertical 0 degrees to 15 degrees. In some embodiments, the second re-entrant angle 102 is 14 degrees.

Referring back to FIG. 3, the first curved surface 64 of the first bowl 56 includes a first curved surface radius 108. The first curved surface radius 108 defines, correspondingly on the first curved surface 64, the lowest point of the first bowl 56 with respect to the piston crown 42 and includes a first curved surface depth 110. The first curved surface depth 110 is in the range of approximately 7 mm to 9 mm. In some embodiments, the first curved surface depth 110 is approximately 7.8 mm. The first curved surface radius 108 is in the range of approximately 5.0 mm to 5.8 mm. In some embodiments, the first curved surface radius 108 is approximately 5.2 mm.

The second curved surface 86 of the second bowl 58 includes a second curved surface radius 112. The second curved surface radius 112 defines, correspondingly on the second curved surface 86, the lowest point of the second bowl 58 with respect to the piston crown 42 and includes a second curved surface depth 114. The second curved surface depth 114 is greater than the first curved surface depth 110. The second curved surface radius 112 is in the range of approximately 9 mm to 10 mm. In some embodiments, the second curved surface radius 112 is approximately 9.4 mm. Further, a center 116 of the second curved surface radius 112 includes a center diameter 118. The center diameter 118 is in the range of approximately 54 percent and 64 percent of the cylinder diameter 19. In some embodiments, the center diameter 118 is approximately 101.7 mm.

FIG. 6 illustrates an embodiment of the combustion bowl 34 including features as described above except for the plurality of pockets 52 recessed into the face 48 of the piston crown 42. As such, the first curved wall 60 transitions continuously into the inner edge 46 of the piston crown 42 at the bowl lip 66, which is generally annular, as opposed to embodiments including the plurality of pockets 52 where the first curved wall 60 transitions into the inner edge 46 at the bowl lip 66 and, between circumferentially successive bowl lips, transitions into each pocket edge 54 at each pocket lip 70.

### INDUSTRIAL APPLICABILITY

In general, the present disclosure may find applicability with pistons utilized in engines for any number of industrial settings such as, but not limited to, mining, earth-moving, agricultural, petroleum extraction, and construction settings. As a non-limiting example, the engine 12 may be a natural gas engine. By utilizing the systems and methods disclosed herein, the first and second bowls 56, 58 of the combustion bowl 34 of the piston 20 provides a combustion chamber 36 which may reduce hydrocarbon emissions. Moreover, the combustion bowl 34 of the present disclosure may also optimize low smoke emissions and reduce the temperature of the cylinder head 16.

For example, during operation of the engine 12, the direct injected fuel via the plurality of nozzles 40 of the fuel injector 38 is divided into the two regions of the first bowl 56 and the second bowl 58. In particular, the fuel that is directed into the first bowl 56 may flow around the first curved surface 64 toward the first curved wall 60 to be directed axially outward and radially inward toward the central longitudinal piston axis 24 as a result of the first re-entrant angle 76 being in the range of approximately vertical 0 degrees to 15 degrees. Similarly, the fuel that is directed into the second bowl 58 may flow around the second curved surface 86 toward the second curved wall 82 to be directed axially outward and radially inward toward the central longitudinal piston axis 24 as a result of the second re-entrant angle 102 being in the range of approximately vertical 0 degrees and 15 degrees. Such distribution of the fuel may promote more efficient combustion and may result in less hydrocarbon emissions, as compared to other designs.

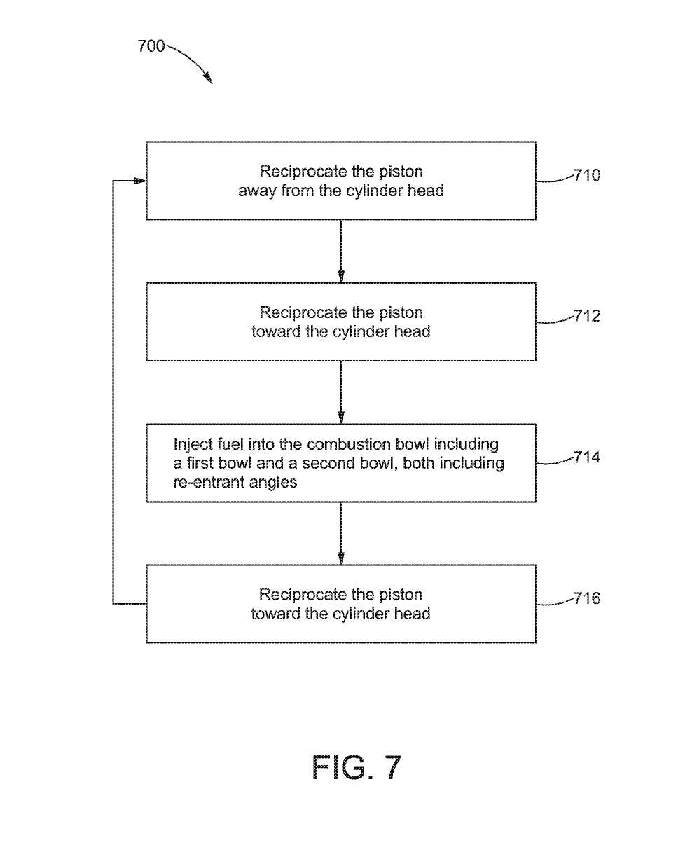

FIG. 7 illustrates a block diagram 700 of a sample sequence which may be performed to operate an engine including a piston operatively disposed in a cylinder of the engine. Block 710 illustrates reciprocating the piston 20 away from the cylinder head 16 of the engine 12 to intake air into the cylinder 18. The piston 20 is then reciprocated toward the cylinder head 16 to compress the air, as illustrated in block 712. With the air compressed, fuel is then injected into the combustion bowl 34 including a first bowl 56 and a second bowl 58, as illustrated in block 714. The first bowl 56 includes a first re-entrant angle 76 for directing the fuel axially outward and radially inward toward the central longitudinal piston axis 24 of the piston 20. Similarly, the second bowl 58 includes a second re-entrant angle 102 for directing the fuel axially outward and radially inward toward the central longitudinal piston axis 24 of the piston 20. After ignition of the fuel reciprocates the piston 20 away from the cylinder head 16, the piston 20 is the again reciprocated back toward the cylinder head 16 to exhaust the cylinder 18, as illustrated in block 716. The piston 20 may then be reciprocated away from the cylinder head 16, as illustrated by the return path to block 710.

1. A piston for an engine, the piston comprising:
a body extending between a first axial region and a second axial region;
a piston crown disposed at the first axial region symmetrically about a central longitudinal axis of the piston;
a first bowl recessed into the body, the first bowl including a first curved wall, the first curved wall transitioning into the piston crown at a bowl lip, the bowl lip including a bowl lip diameter, the first curved wall including a first wall diameter, the first wall diameter being greater than the bowl lip diameter, the first bowl including a first re-entrant angle of 14 degrees from vertical; and
a second bowl recessed into the body and disposed axially inwardly from the first bowl, the second bowl including a second curved wall, the second curved wall transitioning into the first bowl at a peak, the peak including a peak diameter, the second curved wall including a second wall diameter, the second wall diameter being greater than the peak diameter, the second bowl including a second re-entrant angle of 14 degrees from vertical.

2. (canceled)

3. The piston of claim 1, wherein the first re-entrant angle is represented by a first tangent line vertically tangent to the first curved wall at the first wall diameter and a second tangent line tangent to the first curved wall and the bowl lip, and the second re-entrant angle is represented by a third tangent line vertically tangent to the second curved wall at the second wall diameter and a fourth tangent line tangent to the second curved wall and the peak.

4. The piston of claim 1, wherein the first bowl includes a first floor transitioning into the first curved wall at a first curved surface, the second bowl includes a second floor transitioning into the second curved wall at a second curved surface, the first floor includes a first floor angle in a range of 120 degrees to 180 degrees, and the second floor includes a second floor angle in a range of 120 degrees to 180 degrees.

5. The piston of claim 4, wherein the first curved surface includes a first curved surface radius in a range of 5.0 mm to 5.8 mm, and the second curved surface includes a second curved surface radius in a range of 9 mm to 10 mm.

6. The piston of claim 5, wherein the peak includes a peak radius in a range of 0.5 mm to 3 mm.

7. An engine, comprising:
an engine housing including a cylinder disposed therein, the cylinder including a cylinder diameter;
a cylinder head coupled to the engine housing, the cylinder head including a fuel injector disposed therethrough, the fuel injector configured to inject fuel into the cylinder;
a piston operatively disposed in the cylinder, the piston including a piston crown; and
a combustion bowl recessed into the piston and disposed symmetrically about a central longitudinal piston axis, the combustion bowl including a first bowl and a second bowl, the second bowl disposed axially inwardly from the first bowl, the first bowl including a first re-entrant angle of 14 degrees from vertical, the second bowl including a second re-entrant angle of 14 degrees from vertical.

8. The engine of claim 7, wherein the first bowl includes a first curved wall transitioning into the piston crown at a bowl lip, and the second bowl includes a second curved wall transitioning into the first bowl at a peak.

9. The engine of claim 8, wherein the bowl lip includes a bowl lip diameter, the first curved wall includes a first wall diameter, the first wall diameter is greater than the bowl lip diameter, the peak includes a peak diameter, the second curved wall includes a second wall diameter, and the second wall diameter is greater than the peak diameter.

10. The engine of claim 9, wherein the bowl lip diameter is in a range of 80 percent to 90 percent of the cylinder diameter.

11. The engine of claim 9, wherein the peak diameter is in a range of 62 percent to 72 percent of the cylinder diameter.

12. The engine of claim 7, wherein the piston crown includes a plurality of pockets recessed thereinto.

13. A piston for an engine, comprising:
a body extending between a first axial region and a second axial region;
a piston crown disposed at the first axial region symmetrically about a central longitudinal axis of the piston;
a first bowl recessed into the body, the first bowl including a first re-entrant angle; and
a second bowl recessed into the body and disposed axially inwardly from the first bowl, the second bowl including a second re-entrant angle;
wherein each of the first and second re-entrant angles are 14 degrees from vertical.

14. The piston of claim 13, wherein the first bowl includes a first curved wall transitioning into the piston crown at a bowl lip, and the second bowl includes a second curved wall transitioning into the first bowl at a peak.

15. The piston of claim 14, wherein the bowl lip includes a bowl lip diameter, the first curved wall includes a first wall diameter, the first wall diameter is greater than the bowl lip diameter, the peak includes a peak diameter, the second curved wall includes a second wall diameter, and the second wall diameter is greater than the peak diameter.

16. The piston of claim 15, wherein the first re-entrant angle is represented by a first tangent line vertically tangent to the first curved wall at the first wall diameter and a second tangent line tangent to the first curved wall and the bowl lip, and the second re-entrant angle is represented by a third tangent line vertically tangent to the second curved wall at the second wall diameter and a fourth tangent line tangent to the second curved wall and the peak.

17. The piston of claim 16, wherein the first bowl includes a first curved surface depth, the second bowl includes a second curved surface depth, and the second curved surface depth is greater than the first curved surface depth.

18. The piston of claim 17, wherein the first curved surface depth is in a range of 5.0 mm to 5.8 mm and the second curved surface depth is in a range of 9 mm to 10 mm.

19. The piston of claim 18, wherein the first bowl includes a first floor transitioning into the first curved wall at a first curved surface, the second bowl includes a second floor transitioning into the second curved wall at a second curved surface, the first floor includes a first floor angle in a range of 120 degrees to 180 degrees, and the second floor includes a second floor angle in a range of 120 degrees to 180 degrees.

20. The piston of claim 19, wherein the first curved surface includes a first curved surface radius in a range of 5.0 mm to 5.8 mm, and the second curved surface includes a second curved surface radius in a range of 9 mm to 10 mm.
